(19) United States
(12) Patent Application Publication
(10) Pub. No.: US 2007/0045346 A1
(43) Pub. Date: Mar. 1, 2007

(54) Truncheons, protective batons and canes

(76) Inventor: Walter Denis Siteman, Abbotsford (CA)

Correspondence Address: Weldon F Green, 275 King Street East Box 151, Toronto, ON, M5A 1K2, CA

(21) Appl. No.: 10/578,468

(22) PCT Filed: Nov. 8, 2004
(86) PCT No.: PCT/CA04/01933

§ 371 Date: May 5, 2006

(30) Foreign Application Priority Data
Nov. 6, 2003 (CA) 2453171

(51) Int. Cl. B67D 5/64

(52) U.S. Cl. 222/174

(57) ABSTRACT

In an instrument of defense wherein a handle portion (18A, 18B) for a shaft portion (12A, 12B) has a free end and a cavity with a central axis and a mouth (20A, 20B) opening outwardly from the free end for the reception of a spray dispensing unit (26A, 26B) including a spray head mechanism (28A, 28B) with a depending fluid reservoir (26A, 26B), the cavity and reservoir having a mating configuration and extent and of a tolerance such that when aligned and under a press fit sufficient frictional gripping engagement is established therebetween so as to anchor same against separation when transported or in combat; and with the discharge orifice and opposed displaceable spring-biased operating lever (36A, 36B) of the spray bead mechanism (28A, 28B) sufficiently exposed within the cavity mouth (20A, 20B) and at the ready for actuation of same on demand; and further, with the perimeter or edge formation (30A, 30B) of the cavity mouth (20A, 20B) suitably contoured to expose the discharge orifice on the one side and the displaceable spring-biased operating lever (36A, 36B) on the opposed side through a slot formation (32A, 32B) bordered or flanked by a ledge formation (34A, 34B) whereby under displacement of the lever (36A, 36B) within the slot formation fluid spray is dispensed from the discharge orifice and upon displacement of the lever (36A, 36B) out of the slot and in a direction to overlie the ledge formation (34A, 34B) wherein the spray dispensing unit is safely secured against accidental discharge.

### FIELD OF INVENTION

This invention relates to improvements in protective gear and in particular to novel structures or arrangements for truncheons, batons, canes, clubs, staffs or cudgels used for defensive purposes or in combat that include a repellent/deterrent spray component.

More particularly, this invention relates to improvements in the manner of combining such instrument with a repellent/deterrent spray unit and in a disposition that not only greatly facilitates assembly but assures the required security against separation of those components when carried or transported, guards against unintended activation of the spray mechanism of the unit, as well as orients the direction of the spray when the mechanism is activated thereby enhancing the utility of such instrument in resisting any threat, attack or in combat.

### BACKGROUND TO THE INVENTION

Experience of the police, peace officers, security personnel and the incidence of reported attacks upon vulnerable persons such as children, youth, adults, women in particular, and the elderly, in the home, in the streets of a community, in parks and elsewhere where joggers run, prompts an individual who has been or may be threatened or attacked by a dog or other animal, or threatened with bodily harm or attacked by an aggressive person or by a suspected criminal to consider carrying or having in close possession an instrument of defense, for example, in some jurisdictions, a firearm, or when allowed or possible, a repellent/deterrent spray unit, a truncheon, a baton, a cane, a club or a cudgel.

There have been a number of proposals, some recent, relating to the structure and viability of truncheons, batons, canes and like instruments that include the combination of a shaft or an extended rod-like component with a flashlight unit and/or a repellent spray unit.

All appear to employ a level or degree of complexity in terms of their manufacture and operation, in particular, the number of parts required in their assembly and their interconnections for reliable operation, which likely would delay or preclude investment because of cost as well as deter acceptance because of intricacy in the mode of operation of the flashlight and/or the spray head mechanism and also in maintenance of those instruments after purchase.

One example of recent origin is that disclosed by pending US application US2004/0137988A1 published July 2004 in which the combination baton, flashlight and spray dispenser utilizing a number of parts are coupled by a connector; and includes a switch mechanism for engagement with a user's thumb to operate same generally centrally of the longitudinal extent of the unit.

Another recent proposal is to be found in U.S. Pat. No. 6,749,316B1, issued Jun. 15, 2004, detailing a sidearm baton or truncheon with flashlight and camera. The hollow shaft houses the electrical connections for the flashlight and camera with the handle portion housing the switch mechanism for activating the circuits.

Similarly U.S. Pat. No. 6,499,855B1, issued Dec. 31, 2002, outlines the structure of an extendible police baton which, in one embodiment, includes a flashlight, a pepper sprayer and a glass breaker with the pepper sprayer serving as the outwardly extending sidearm in a truncheon-like configuration.

Still other complex structures appear in pending US application US2002/0163799A1, published Nov. 7, 2002, as well as in U.S. Pat. No. 6,386,726B1, issued May 14, 2002.

Another arrangement is to be found in U.S. Pat. No. 5,405,134, issued Apr. 11, 1995, in which a truncheon-like structure appears with a hollow handle extending from an adjustable collar designed to encircle and be secured to a club, flashlight or other shaft. A chemical canister is disposed within the hollow which is provided with screws that extend through the surrounding grip so as to bear against the canister to anchor same therewithin; and with a thumb engaging element overlying the outer end of the bore of the handle to activate the spray head of the chemical canister.

In the aforementioned US patent the repellent is described as a mace canister commercially available and designed to discharge mace from a nozzle in the spray head mechanism, one such product being identified as M602 personal size mace available from security supply dealers. Such a commercial unit, if available, could be chosen as an element in the combinations of the embodiments of this invention illustrated and described herein.

A dog repellent with maximum strength 5.0% Oleoresin Capsicum licensed by the Federal Government of Canada, PCP No. 23548, is packaged in a spray unit with a generally cylindrically shaped reservoir and is available for purchase.

This particular repellent spray unit presents a spray in a cone shape and fires in a range of up to 16 feet.

Another earlier example of a combination flashlight and repellent discharge device is disclosed by U.S. Pat. No. 3,776,429, issued Dec. 4, 1973.

A close examination of the aforementioned publications reveals several limiting factors to efficient profitable production of the instruments, namely the number of necessary parts, the steps required in their assembly and consequent testing procedures. Also inherent in those arrangements is the concern over or obstacle to transporting same, as for example, when jogging, or in providing storage or concealment on the person; and also maintenance will be a concern and must be taken into consideration when making a decision to purchase such a unit.

### OBJECTS OF THE INVENTION

A strong need for a readily available instrument for protection against threats of harm or injury by dogs and other animals or by a person or persons continues. It is therefore a principal object of this invention to provide an improved instrument in the form or configuration of well established protective gear such as a truncheon, baton or cane that incorporates and combines with a deterrent/repellent spray unit available in the marketplace in a more simplified arrangement and which is secure against dislodgment in use and at the ready for instant discharge of spray; and of a weight that will prove in use an effective tool for discouraging or resisting threats of injury, aggression or attack and reliable in combat to overcome an assailant; and have an appearance that signifies strength and a willingness to resist.

In addition all the foregoing lays the foundation for attracting investment in the efficient profitable production of such protective gear, which followed by promotion and widespread distribution and acceptance of same by the public generally as well as by police officers and security personnel will impart a sense of greater control over the safety of an individual and of the safety of all persons in the community; and tend in the long run to discourage or deter those who would threaten or inflict harm.

Another object is to provide a selection of instruments that suit the circumstances, namely be carried or stored and can easily be concealed; all of which can be supplied in light, medium or heavy duty embodiments.

Still another very important object is to provide to members of the community an appropriate choice of instrument for the ready and effective defense of their particular person and their families and thereby facilitate the safety of passage for all citizenry.

### FEATURES OF THE INVENTION

One important feature of this invention resides in providing a preferred disposition of a recessed handle portion of the instrument for the reception of the deterrent/repellent spray unit in relation to the shaft portion thereof in a form that particularly suits the user or the use to which the instrument will be put.

More particularly the recessed handle portion can appear as an extension of the shaft portion as in a baton, as at a right angle and near to one end of the shaft portion as in a truncheon, or as a portion of the handle as in a cane.

The principal feature, in each case, is the selection of the configuration of the recess or cavity for the handle portion to match the uniform shape of the reservoir of a selected deterrent/repellent spray unit so that a press fit of reservoir into recess or cavity can be effected and so suitably anchored therein.

The force exerted in the step of press fitting is of the order that the wall of the filled reservoir engages the surrounding wall of the recess or cavity in a sufficiently binding manner such that the components are held against separation under those conditions encountered in a defense mode or in combat; and when the deterrent/repellent fluid is depleted or exhausted the partially empty or emptied reservoir can be withdrawn or retracted for replacement by exerting a reasonable force in the opposite directions.

Accordingly, the tolerance applied to the shaping of the recess or cavity in the manufacturing step to conform to the designated uniform shape of the selected spray unit will achieve the desired resistance to separation and will be set or established by those persons skilled in the field having regard to surface characteristics of the reservoir, of the selected spray unit and the material or composition of the handle, for example, as turned from a wooden block or as molded from a suitable plastic or otherwise.

It will be understood that the instruments in question must have clout so that, if necessary, an attack can be warded off by administering a blow or blows to the assailant Therefore materials or compositions suitable for that purpose and known to those skilled in this market segment, will be chosen.

These and other objects and features will become apparent from the following description to be read in conjunction with the accompanying sheets of drawings.

### DRAWINGS

FIG. 1 is a perspective view taken from above of a truncheon or side arm or side handle instrument embodying the invention illustrating the step of assembly of a spray canister shown in broken outline into integral relationship within such instrument;

FIG. 2 is a top plan view of the truncheon with assembled spray canister of FIG. 1;

FIG. 3 is a side elevational view of the truncheon with assembled spray canister of FIG. 2;

FIG. 4 is an end elevational view of the truncheon with assembled spray canister of FIGS. 2 and 3 taken from the right end thereof;

FIG. 5 is a perspective view taken from above of a baton embodying the invention illustrating the step of assembly of a spray canister shown in broken outline into integral relationship within such instrument;

FIG. 6 is a side elevational view of the baton with assembled spray canister of FIG. 5;

FIG. 7 is a front elevational view of the baton with assembled spray canister of FIG. 6;

FIG. 8 is a bottom plan view of the lower end of the baton of FIGS. 5, 6 and 7;

FIG. 9 is a perspective view of a cane structure embodying the invention illustrating the step of assembly of a spray canister shown in broken outline into integral relationship with such instrument;

FIG. 10 is an enlarged section in side elevation of the handle formation of the structure of FIG. 9, broken away, detailing the assembled spray canister shown in broken outline in integral relationship with such instrument; and

FIG. 11 is a perspective view of a preferred structure of an available commercial spray canister depicted in broken outlines in the foregoing figures.

### DESCRIPTION OF THE DRAWINGS

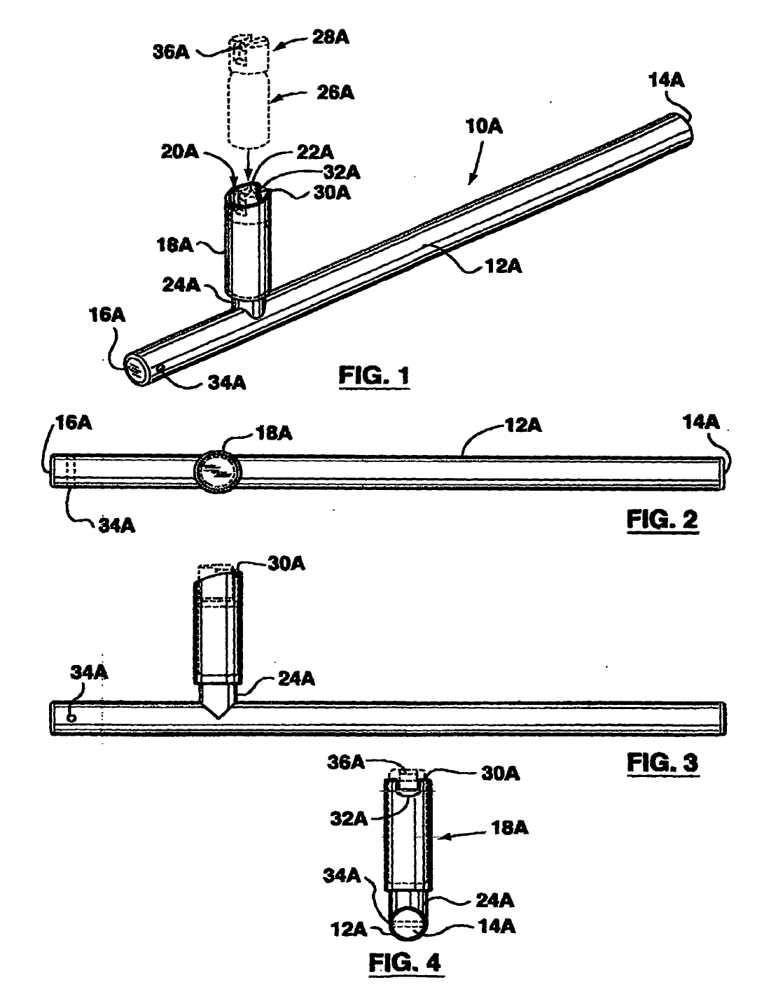

The embodiment of the invention illustrated in FIGS. 1 to 4 inclusive takes the form of a truncheon-like or side-arm instrument indicated generally at 10A.

The instrument 10A includes a shaft or rod 12A having suitably chamfered truncated ends 14A, 16A.

Upstanding at generally right angles to the shaft or rod 12A nearer to one end of the shaft than the other, is a handle 18A with a recess or cavity having a mouth opening as at 20A with the recess or cavity having a selected contour 22A, which is depicted generally as of a cylindrical shape.

The recessed handle 18A is mounted upon a stem portion 24A which integrally connects the handle 18A to the shaft or rod 12A.

Above the mouth opening 20A in FIG. 1 appears a reservoir 26A, in broken outline, of a selected spray dispensing unit 28A to be acquired from a commercial source and presenting a uniform configuration, in this instance one that has a central axis, presenting a cylindrical shape.

Other configurations with a central axis could be utilized such as a reservoir with a square, rectangular or ovate cross-section.

The contour or shape 22A of the recess or cavity wall of handle 18A mirrors the cylindrical shape of the reservoir 26A to a tolerance that establishes sufficient frictional gripping engagement of the respective surfaces when reservoir 26A is fully inserted into the recess or cavity to be accomplished by a press fit so that disengagement is effectively controlled or prevented.

The reservoir 26A is secured within the recess or cavity of handle 18A by applying directional thrust to those aligned components; and removal accomplished in reverse after depletion of the pressurized liquid deterrent/repellent with a strong pull in opposite directions.

Such simplified arrangement reducing to two complementary components obviously leads to efficient production and compared to other more complex models more useful overall as well as appealing in appearance as an instrument of strength and defense.

The axial extent of the upwardly opening recess or cavity of handle 18A is also measured to match the axial extent of the spray dispensing unit 28A such that the uppermost spray head mechanism is sufficiently exposed in the region of the cavity mouth 20A for the actuation of same on demand when the reservoir is fully inserted and in conformity to the contoured outline of the perimeter or upper edge 30A of cavity mouth 28A as will appear.

FIGS. 3 and 4 of the drawings reveal that the upper edge 30A has a downward inclination towards the end 16A of the shaft or rod 12A thereby exposing the orifice of the spray head mechanism of the spray dispensing unit for discharge of the deterrent/repellant outwardly forwardly in aligned relation with the shaft or rod 12A.

FIGS. 1 and 4 show further detail of edge formation 30A in the form of a generally U-shaped slot 32A facing the opposite end of shaft or rod 18A and aligned therewith.

It will be observed that the U-shaped slot 32A is flanked by generally level sections of the edge formation 30A to register with a ledge formation 34A of the spray head mechanism 28A supporting the operating lever 36A in the “off” position as depicted in FIG. 11 of the drawings.

Lever 36A is pivotally supported within reservoir 26A and spring biased so that upon displacement of lever 36A in a direction to register with slot 32A and the depression of lever 36A thereinto the pressurized deterrent/repellent spray liquid is released through the orifice in the direction of the end 16A of shaft or rod 12A and preferably a cone shape.

Thus this instrument can be used as a defense to a threatened approach by an assailant through ready disposition of the shaft or rod 12A in the direction of the target followed by or simultaneously with finger or thumb movement displacing lever 36A to slot 32A and depressing same to deliver a pattern of deterrent/repellent spray onto the assailant.

If no retreat of the attacker occurs a blow can then be administered with the shaft or rod 12A using the handle 18A as a hand grip or the user escape to safety or run to summon help.

It is also to be noticed that the girth of the handle 18A preferably exceeds that of the girth of the shaft or rod 12A in that the handle portion serves as a hand grip when fending off a blow with the shaft or rod 12A, or using the end 14A to prod the attacker; and indeed with lesser girth the weight of the instrument is reduced without an appreciable sacrifice of strength.

It will also be noted that the instrument of FIGS. 1 to 4 is provided with an aperture therethrough designated 37A so that a suitable tie or thong can be threaded through it for securement to a belt or for hanging from a hook.

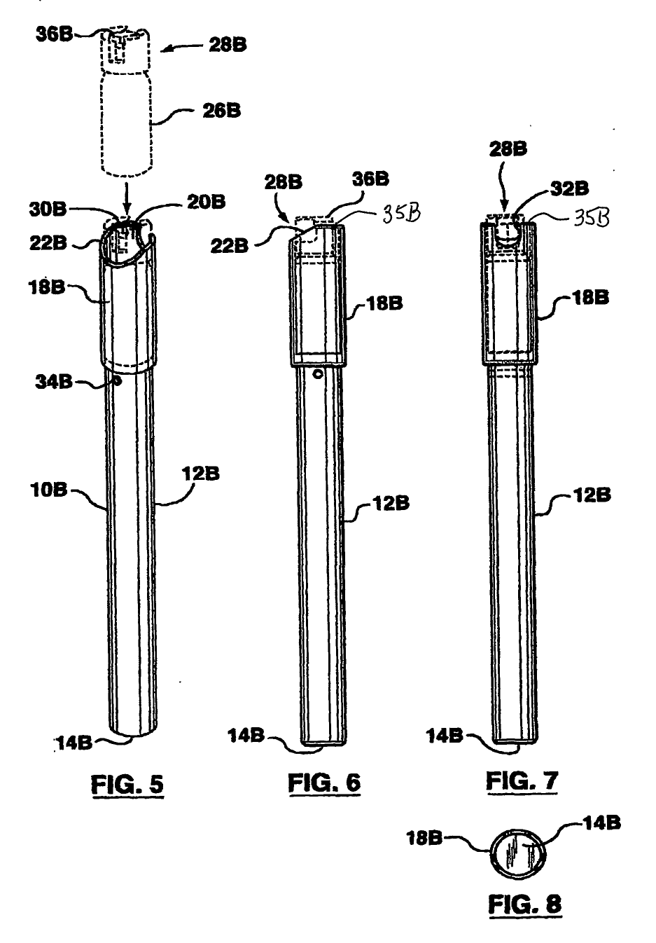

The embodiment of the invention illustrated in FIGS. 5 to 8 inclusive takes the form of a baton indicated generally at 10B.

The instrument 10B includes a shaft or rod portion 12B having a suitably chamfered truncated lower end 14B.

Extending upwardly in alignment with the shaft or rod portion 12B and integral therewith is a handle portion 18B with a recess of cavity having a mouth opening as at 20B and with a selected internal contour 22B depicted as of a cylindrical shape.

Above the mouth opening 20B in FIG. 5 a reservoir 26B of a selected spray dispensing unit 28B appears in broken outline. Such a unit, as in the case of the embodiment of FIGS. 1 to 4 inclusive, is to be acquired from a commercial source and likewise having uniformity or presenting a uniform configuration in cross section.

The contour or shape 22B of the cavity wall of handle portion 18B mirrors the shape of the cylindrical reservoir 26B to a tolerance that establishes full frictional gripping engagement of the respective surfaces when reservoir 26B is press fit into the recess or cavity to effectively resist or prevent disengagement over a range of applied forces in use; and to be accomplished in the manner of the embodiment illustrated in FIGS. 1 to 4 by applying directional thrust to aligned component handle portion 18B and reservoir 26B whereby a secure connection is established upon full registration.

Likewise, as in the case of the embodiments of FIGS. 1 to 4 the axial extent of upwardly opening recess or cavity of handle portion 18B matches the axial extent of the spray dispensing unit 28B so that the spray head mechanism thereof is sufficiently exposed in the region of the cavity mouth 20B for generating a spray.

Similarly, the perimeter or upper edge 30B of cavity mouth 28B is contoured to incline downwardly in a direction opposed to generally U-shaped slots 32B flanked by generally level ledge formations 35B as best seen in FIGS. 6 and 7 of the drawings; and all in relation to the structure of the spray head mechanism including the lever 36B as described in relation to the embodiments of FIGS. 1 to 4.

An aperture 34B through the shaft portion 12B serves as a passage for threading a tie therethrough.

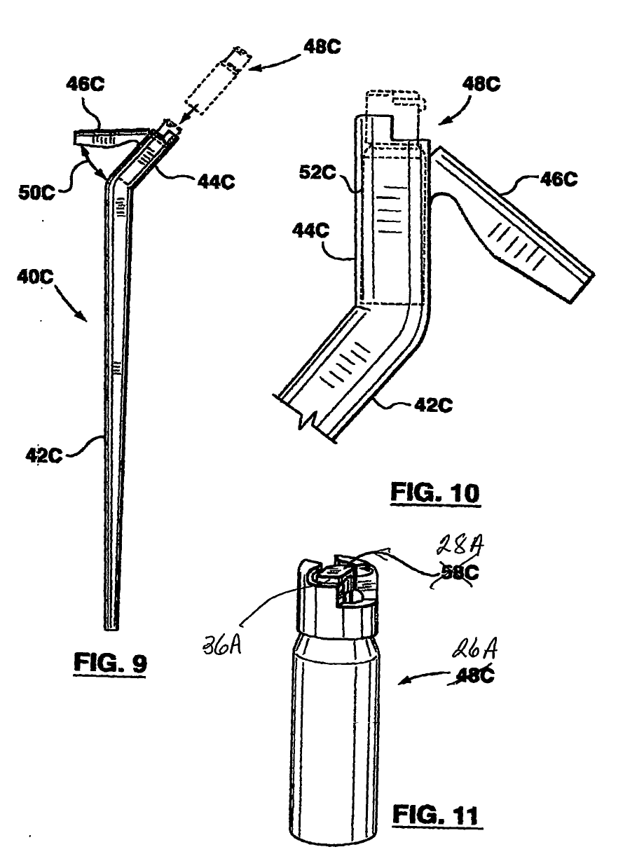

The embodiment of the invention illustrated in FIGS. 9 and 10 inclusive takes the form of a cane indicated generally at 40C.

Cane 40C includes a shaft 42C terminating upwardly in an inclined recessed handle portion 44C which in turn supports a handgrip portion 46C having a generally horizontal disposition.

In the preferred embodiment the contained angle between the shaft 42C and the recessed handle 44C is obtuse whereas the contained angle between the recessed handle portion 44C and hand grip 46C is acute.

As in the case of the embodiments of FIGS. 1 to 4 and 5 to 8 inclusive a deterrent/repellent spray unit is to be press fit in the recessed handle 44C and exhibit the same characteristics of recessed handle and the spray unit as detailed in relation to those embodiments.

The cane embodiment 40C of FIGS. 9 and 10 can be manipulated through the hand grip 46C to direct a pattern of spray onto the assailant by displacement of the operating lever of the spray head mechanism, all as earlier described and with the cane 40C in the disposition of FIG. 9 either on the ground or supported above the ground to target the assailant's upper body.

Similarly, the cane 40C can be wielded to strike a blow in defense.

It will be understood that whereas the preferred embodiments of the invention have been illustrated and described, persons skilled in this field may alter or vary the details of the arrangements without departing from the spirit and scope of the appended claims.

1. In an instrument of defense wherein the handle portion for an integral shaft portion has a free end and a cavity with a mouth opening outwardly from the free end thereof for the reception of a spray dispensing unit including a spray head mechanism with a depending fluid reservoir, the cavity and reservoir having an axis of alignment and mating configuration and extent and of a tolerance such that when aligned and mated under a press fit sufficient frictional gripping engagement is established therebetween so as to anchor same against separation when transported or in combat and with the spray head mechanism sufficiently exposed at the cavity mouth and at the ready for actuation of same on demand.

2. In an instrument of defense, a handle portion for an integral shaft portion, the handle portion having a free end and a cavity with a mouth opening outwardly from the free end thereof for the reception of a spray dispensing unit including a spray head mechanism with a discharge orifice on one side, a displaceable spring-biased operating lever disposed toward the other side and with a depending fluid reservoir, the cavity and reservoir having an axis of alignment and a mating configuration and extent and of a tolerance such that when aligned and mated under a press fit sufficient frictional gripping engagement is established therebetween so as to anchor same against separation and with the spray head mechanism disposed within the cavity mouth, the cavity mouth presenting a surrounding edge formation with a suitable contour exposing the discharge orifice on one side and with a slot bordered by a ledge formation exposing the displaceable spring-biased operating lever on the other side for displacement within the slot to dispense fluid spray and for displacement to the ledge formation to secure same against accidental discharge.

3. An instrument according to claims 1 or 2 wherein said cavity mouth of said handle portion opens outwardly in spaced apart relation to one end of said shaft portion.

4. An instrument according to claims 1 or 2 wherein said handle portion is disposed at an obtuse angle to said shaft portion.

5. An instrument according to claims 1 or 2 wherein said cavity mouth of said handle portion opens outwardly intermediately of the extent of said shaft portion and in spaced apart relation thereto.

6. An instrument according to claims 1 or 2 wherein said handle portion is disposed at substantially right angles to said shaft portion and towards one end.

7. An instrument according to claims 1 to 6 inclusive wherein the girth of said handle portion exceeds that of said shaft portion.

8. An instrument according to claims 1 or 2 wherein said handle portion and said shaft portion have the configuration of a truncheon.

9. An instrument according to claims 1 or 2 wherein said handle portion and said shaft portion have the configuration of a baton.

10. An instrument according to claims 1 or 2 wherein said handle portion and said shaft portion have the configuration of a walking cane.

11. An instrument according to claims 1 to 10 inclusive wherein said shaft portion is suitably apertured for reception of a tie or thong for supporting same for carriage or storage.
